(19) United States
(12) Patent Application Publication
(10) Pub. No.: US 2014/0229555 A1
(43) Pub. Date: Aug. 14, 2014

(54) PRODUCTIVITY SYSTEM WITH EVENT-DRIVEN COMMUNICATIONS MANAGER, METHOD AND PROGRAM PRODUCT THEREFOR

(71) Applicant: INTERNATIONAL BUSINESS MACHINES CORPORATION, Armonk, NY (US)

(72) Inventors: Lisa Seacat DeLuca, San Francisco, CA (US); Soobaek Jang, Hamden, CT (US); Michael Muller, Medford, MA (US)

(73) Assignee: INTERNATIONAL BUSINESS MACHINES CORPORATION, Armonk, NY (US)

(21) Appl. No.: 13/766,768

(22) Filed: Feb. 13, 2013

(51) Int. Cl. H04L 12/58

(52) U.S. Cl. CPC H04L 51/02
USPC 709/206

(57) ABSTRACT

A productivity system, method and a computer program product therefor. A communications client, e.g., email, for an address identified with a user receives communications. Events for the identified user are listed, e.g., scheduled on a calendar. An event-driven communications manager interactively coordinates communications delivery to the address responsive to scheduled events. In particular, communications, such as emails, may be selectively delayed during one or more said scheduled events, e.g., virtual meetings.

### BACKGROUND OF THE INVENTION

1. Field of the Invention

The present invention is related to network based communications and more particularly to controlling email delivery.

2. Background Description

Electronic communications have become ubiquitous in, and an integral part of, the modern workplace. In particular, email is a critical element of workplace communications. These electronic communications have enabled businesses to allow workers to telecommute or telework, where the workers participate in the particular business without actually being on site or even geographically close to the same location. Moreover, virtual meetings and conferences have proliferated because electronic communications have made these real-time virtual assemblies nearly interchangeable with the in-person equivalent, often at a dramatically reduced cost.

However, an email during a meeting can be distracting to the recipient and take the focus away from the subject at hand. Consequently, email deliveries can make meetings less productive. Thus, it is a common practice for meeting leaders or moderators to ask attendees to close computers and other applications (e.g., cell phones, email clients and instant messenger clients) that might cause a distraction. Unfortunately, it has been hard to control or limit other electronic communications, such as emails, that might disrupt on-going virtual assemblies.

Thus, there is a need for reducing distractions caused by emails during virtual meetings and conferences, and more particularly, for managing email delivery to virtual assembly attendees.

### SUMMARY OF THE INVENTION

A feature of the invention is email delivery is selectively delayed or delivered during meetings;

Another feature of the invention is email delivery is automatically delayed or delivered during scheduled meetings;

Yet another feature of the invention is email delivery is selectively, automatically postponed during scheduled meetings.

The present invention relates to a productivity system, method and a computer program product therefor. A communications client, e.g., email, for an address identified with a user receives communications. Events for the identified user are listed, e.g., scheduled on a calendar. An event-driven communications manager interactively coordinates communications delivery to the address responsive to scheduled events. In particular, communications, such as emails, may be selectively delayed during one or more said scheduled events, e.g., virtual meeting.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a preferred productivity system with a preferred event-driven communications manager, selectively delaying delivery of email messages to user devices according to a preferred embodiment of the present invention;

FIG. 2 shows an example of a preferred event-driven communications manager delaying messages in a preferred system;

FIG. 3 shows a particular example of a graphical user interface for a preferred event-driven communications manager.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

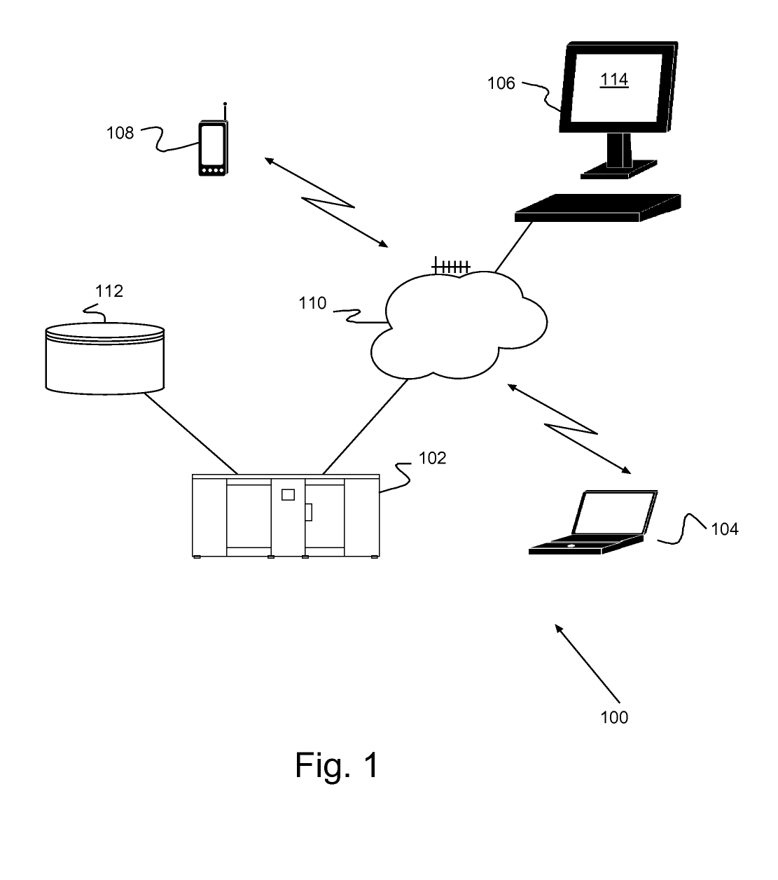

Turning now to the drawings and more particularly, FIG. 1 shows an example of a preferred productivity system 100 with a preferred event-driven communications manager, selectively delaying delivery of email messages to user devices, e.g., during meetings and especially virtual meetings, as selected by previously set individual user preferences, according to a preferred embodiment of the present invention. The preferred system 100 includes one or more computers 102, 104, 106, 108 cooperatively running individual productivity applications or apps, or optionally, a productivity suite, including one or more email clients, one or more calendar clients and a preferred event-driven communications manager. In particular, the preferred event-driven communications manager coordinates email delivery in response to scheduled appointments or events, selectively delaying emails that might interrupt an ongoing important meeting, while selectively delivering emails during meetings of lesser importance.

The computers 102, 104, 106, 108 are networked together, and communicating with one another, wired or wirelessly, over a network 110. In this example, the computers 102, 104, 106, 108 include a server 102, a portable computer (e.g., a laptop, notebook, netbook computer) 104, a desktop or personal computers (PC) 106, and a mobile computer (e.g., a smart phone, personal digital assistant (PDA), a tablet computer, or a thin client) 108. Also, one or more of the computers 102, 104, 106, 108 may include non-volatile storage 112, e.g., a hard disk drive, a flash drive, flash memory, or a solid state disk drive (SSDD). At least one of the computers includes a display, e.g., 114, for interfacing with the system 100 through a graphical user interface (GUI).

Although the preferred event-driven communications manager is described herein as part of, embodied, in and operating in cooperation with, a stand-alone productivity suite(s), e.g., Microsoft Office or Oracle E-Business Suite, the present invention has application to use with any email and calendar capability. Thus, any suitable collection of an email client receiving emails to, and sending emails from, an email address identified with a user, cooperating with a calendar client for interactively managing scheduled appointments for the user, e.g., Google Calendar and Gmail. Further, the preferred event-driven communications manager also has application, for example, in devices that include both an individual email capability and calendar capability, such as a state of the art smart phone 108 or a PDA.

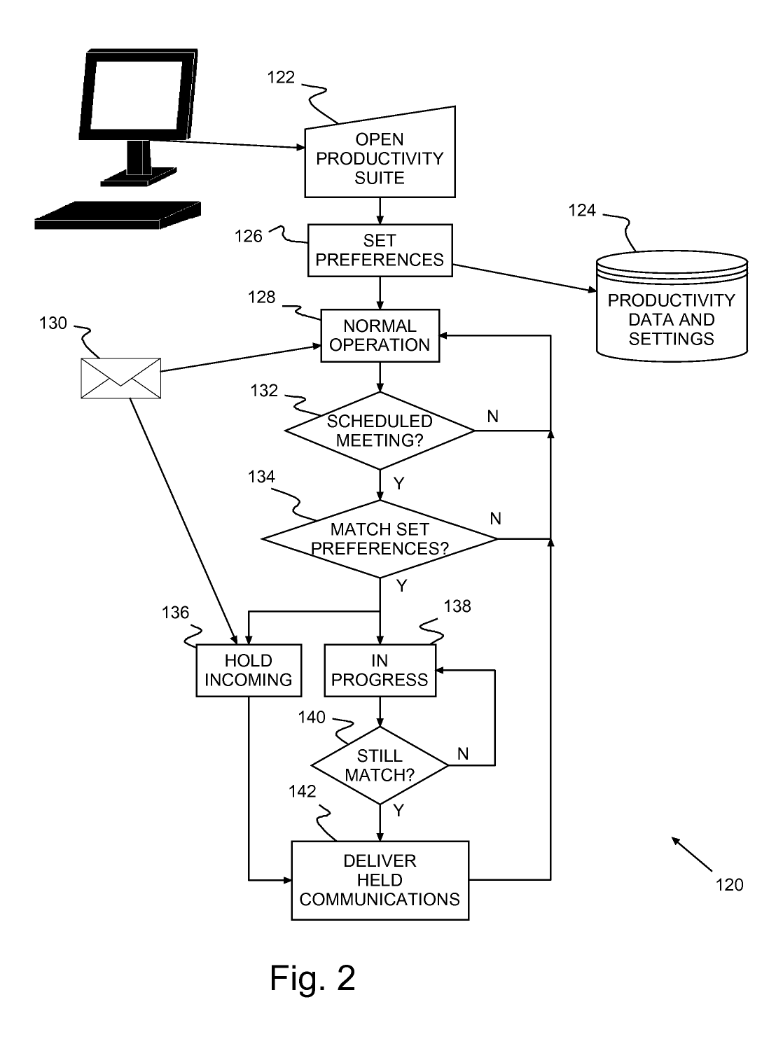

FIG. 2 shows an example of a preferred event-driven communications manager delaying messages 120 in a preferred system (e.g., 100 in FIG. 1) according to a preferred embodiment of the present invention. In this example, when a user opens the calendar client and email client 122, the event-driven communications manager opens. Email preferences 124 are set 126 for a meeting, e.g., interactively through PC 106. The email preferences may be set 126 by default, when the meeting is scheduled or subsequently, e.g., to delay delivery for specific users or under specific conditions. Thereafter, the calendar and email client operate normally 128, e.g., email delivery 130 continues, until a scheduled meeting time arrives 132. If the previously set preferences for the meeting do not restrict delivering emails 134; then, the calendar and email client continue operating normally 128. Otherwise, if the set preferences match 134 for the meeting, the event-driven communications manager selectively causes email to be held 136 temporarily, e.g., while the meeting is in session 138 or for a portion of the meeting. When the hold period ends, e.g., the meeting finishes 140, the event-driven communications manager delivers 142 the held email and returns to normal operation 128.

The event-driven communications manager may open automatically in response to, or as part of, opening the productivity suite, calendar or email client 120. Alternately, the particular user may specifically open the event-driven communications manager. Email notification preferences may be set 126, for example, by default, coincident with scheduling a new meeting or event, or by selecting a previously scheduled meeting and modifying preferences for the meeting, e.g., through a GUI. The user can specify different features for different meetings when setting preferences 126. Optionally, the user can change settings 124 during an ongoing meeting 138 to begin delaying emails 136, e.g., if the user forgot to set the preferences 126 prior to the meeting; or, the user can reset the preferences 124 to release delayed emails or communications 142 and deliver some or all new emails normally 128. Thus, depending on the importance of the particular meeting, arrival of new email messages need not distract other attendees.

For example, email can be held for all meetings by default. All held emails may be held by the email server 102 or a local email client may delay send/receive commands to the email server 102. Further, the settings may select individual specific meetings or a portion of a meeting. The settings may restrict delaying emails to only those meetings where attendance is required for the respective user. Also, the user may designate those meetings attended by another participant or group of participants. These groups may include, for example, a defined Lightweight Directory Access Protocol (LDAP) group, direct reports to the configuring user or another user (e.g., an administrative assistant scheduling a department meeting), a respective management chain, a particular email address, individuals falling within two degrees of friendship in a social network application, and/or any other desired group definition.

Until a scheduled event commences, e.g., a meeting begins, the event-driven communications manager transparently allows normal email delivery 128. At the scheduled meeting time 132, and when the respective user attends the meeting, the event-driven communications manager checks 134 the set preferences 124. If the preferences 124 do not qualify the current meeting for delaying emails, email delivery continues normally 128. Otherwise, however, if the preferences specify delaying emails during the current meeting, i.e., a match 134, the event-driven communications manager system delays 136 incoming communications.

For example, the email server (102 in FIG. 1) may hold emails 136 by default until either the meeting ends 140 or optionally, the respective preferences 124 are changed during the meeting. Alternately, the event-driven communications manager may postpone 136 checking the email server 102 until either the meeting ends 140 or the respective preferences 124 are changed. Once the meeting ends 140 or, the respective preferences 124 are changed, the held email is released or requested and delivered 142, and delivery continues normally 128 until the next meeting.

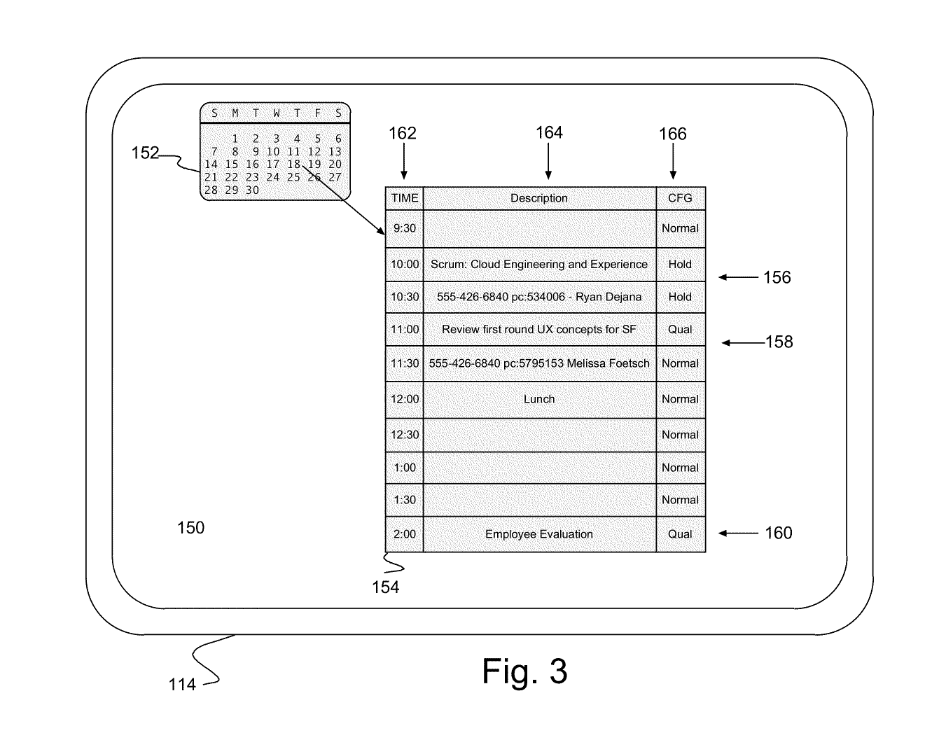

FIG. 3 shows a particular example of a graphical user interface 150 for a preferred event-driven communications manager, e.g., on a display 114 on one of computers 104, 106, 108 in FIG. 1. The particular computer 104, 106, 108 has an open email client (not shown) and calendar 152. A specific day 154 is selected on the calendar 152 listing meeting times 156 158, 160. In addition to listing the meeting times 162 and description 164, each entry in the day listing 154 includes notification preference indication 166. The notification preference indication 166 shows normal operation except during scheduled meetings 156 158, 160. The settings 166 for the first meeting 156 are set to hold all email during the entire meeting. The settings 166 for the second meeting 158 are a qualified hold, e.g., set to hold all email during the first half hour of the meeting, with delivery of held email at the end of the first half hour and normal delivery thereafter. Likewise, the settings 166 for the third meeting 160 are a qualified hold, e.g., all emails below a selected priority are held and emails with higher priority emails delivered.

The email client may replicate settings locally or, the preferred event-driven communications manager may work with server (e.g., 102) directly. When the first meeting starts at 10:00 am, as indicated on the day list 154 entry 156, the entry 156 indicates that the meeting requires no distractions, e.g., the particular user is leading the meeting or presenting. The preferred event-driven communications manager suspends incoming email delivery, e.g., either by locally halting receive requests from the email client, or at the server 102 by holding emails until the meeting ends at 10:59. When the first meeting ends according to calendar entry 156, either it automatically or manually is marked finished at 10:59, and the suspended delivery mode is released, accepting incoming emails normally until the next meeting begins at 11:00. Likewise in the second meeting 160, emails are held for the first half hour, released at 11:30 and delivered normally thereafter until the last meeting 162 begins. Optionally, at any time during any meeting 158, 160, 162, the respective user or another authorized user could disable the hold feature, e.g., if the user decides the on-going meeting no longer demands full attention or, if the user is waiting for a specific email.

Thus advantageously, the preferred event-driven communications manager removes potential distractions from meetings. The present invention allows for filtering emails automatically depending on importance to the user or the necessity of automatically keeping the user free from distractions, especially for attendees of virtual meetings.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A productivity system comprising:
an communications client receiving communications to an address identified with a user;
a stored storing a list of scheduled events; and
an event-driven communications manager coordinating communications delivery to said address responsive to said scheduled events.

2. A productivity system as in claim 1, wherein said communications client is an email client, and said event-driven communications manager interactively configures selective delay of emails to said email client during one or more said scheduled events.

3. A productivity system as in claim 2, further comprising a plurality of computers, an email server being on a first computer and said email client being on a second computer, and said event-driven communications manager interactively configures said email server to selectively delay said emails to said email client.

4. A productivity system as in claim 3, wherein said email client and said calendar client are on the same said computer and said event-driven communications manager configures said email server by default to delay email delivery for all scheduled events for the duration of each of said scheduled events.

5. A productivity system as in claim 2, wherein said event-driven communications manager selectively configures said email server to hold email for one or more identified email users only during a portion of one or more specific scheduled events.

6. A productivity system as in claim 2, wherein said event-driven communications manager restricts delaying emails to members of a group of email users.

7. A productivity system as in claim 6, wherein said group of email users is selectively defined as one of a Lightweight Directory Access Protocol (LDAP) group, direct reports to the configuring said identified user, members of a selected management chain, and individuals falling within a number of degrees of friendship in a social network application.

8. A productivity system as in claim 2, wherein said event-driven communications manager restricts delaying emails to only those meetings where attendance is required for the respective user.

9. A productivity system as in claim 2, further comprising a display, wherein said event-driven communications manager comprises a graphical user interface (GUI), said display displaying said GUI for configuring delaying emails.

10. A productivity system as in claim 2, wherein at least one of said one or more scheduled events is a scheduled virtual meeting.

11. A productivity method comprising:
opening an event-driven communications manager;
setting preferences for communications with one or more associated users, said event-driven communications manager setting said preferences, each of said one or more associated users being identified with an address;
monitoring for scheduled events for each of said associated users until commencement of a scheduled event;
holding communications for said associated users upon commencement of said scheduled event;
waiting for completion of said scheduled event;
delivering held said communications upon completion of said scheduled event; and
returning to monitoring for scheduled events.

12. A productivity method as in claim 11, wherein said communications comprise emails, said productivity method further comprising opening a calendar and an email client with said event-driven communications manager, said preferences being set with each respective event scheduled in said calendar and indicating whether emails are held or delivered during respective events.

13. A productivity method as in claim 12, wherein said event-driven communications manager comprises a graphical user interface (GUI), a first user setting said preferences to designate delaying emails during meetings attended by one or more meeting participants.

14. A productivity method as in claim 13, wherein said one or more meeting participants is one or more groups of email users selectively defined as one of: a Lightweight Directory Access Protocol (LDAP) group, direct reports to the respective said identified user, members of a selected management chain, and individuals falling within a number of degrees of friendship in a social network application.

15. A productivity method as in claim 12, upon commencement of said scheduled event, said productivity method further comprising:
checking whether conditions of said scheduled event match said set preferences, emails being held at least during a defined portion of said scheduled event when said conditions match; and otherwise
returning to monitoring.

16. A productivity method as in claim 15, wherein waiting for completion further comprises:
selectively changing preferences, changed preferences unmatching matched said conditions;
releasing held emails responsive to unmatched said conditions; and
continuing to delivering held said communications.

17. A productivity method as in claim 12, wherein said event-driven communications manager sets said preferences with an email server selectively transferring emails with said email client, said email server selectively delaying emails during said scheduled events responsive to set said preferences.

18. A productivity method as in claim 12, wherein said event-driven communications manager sets said preferences with said email client, said email client selectively delaying email receive transmissions during said scheduled event responsive to set said preferences.

19. A computer program product for managing communications, said computer program product comprising a computer usable medium having computer readable program code stored thereon, said computer readable program code comprising:
computer readable program code means for receiving communications to an address identified with a user;
computer readable program code means for managing scheduling events for said identified user; and
computer readable program code means for interactively coordinating communications delivery responsive to scheduled said events.

20. A computer program product for managing communications as in claim 19, wherein said communications comprise emails, said computer readable program code means for receiving comprises computer readable program code means for an email server and an email client, said computer readable program code means for interactively coordinating comprising computer readable program code means for interactively setting preferences to selectively delay emails to said email client during one or more said scheduled events.

21. A computer program product for managing communications as in claim 20, wherein said computer readable program code means for interactively setting preferences comprises:
computer readable program code means for a graphical user interface (GUI);
computer readable program code means for selectively setting said preferences to hold email for one or more identified email users through said GUI during any portion of specific scheduled events; and
computer readable program code means for selecting through said GUI a group of email users for delaying emails.

22. A computer program product for managing communications as in claim 21, wherein said computer readable program code means for selecting said group selects email users from: a Lightweight Directory Access Protocol (LDAP) group, direct reports to one identified user, members of a management chain, email users required to attend said scheduled meeting, and individuals falling within a number of degrees of friendship in a social network application.

23. A computer program product for managing communications, said computer program product comprising a computer usable medium having computer readable program code stored thereon, said computer readable program code causing one or more computers executing said code to:
open an event-driven communications manager;
set preferences for communications with one or more associated users, said event-driven communications manager setting said preferences, each of said one or more associated users being identified with an email address;
monitor for scheduled events for each of said associated users until commencement of a scheduled event;
hold communications for said associated users upon commencement of said scheduled event;
wait for completion of said scheduled event;
deliver held said communications upon completion of said scheduled event; and
return to monitoring for scheduled events.

24. A computer program product for managing communications as in claim 23, wherein said communications are emails, said computer readable program code further causing said one or more computers executing said code to:
open a calendar and email client with said event-driven communications manager, set said preferences indicating whether emails are held or delivered during events scheduled in said calendar; and upon commencement of said scheduled event
check whether conditions of said scheduled event match said set preferences, emails being held at least during a portion of said scheduled event when said conditions match; and otherwise
return to monitoring.

25. A computer program product for managing communications as in claim 24, said computer readable program code for waiting for completion further causing said one or more computers executing said code to:
selectively change preferences, changed preferences unmatching matched said conditions;
release held emails; and
continue to delivering held said communications.
